(19) United States
(12) Patent Application Publication
(10) Pub. No.: US 2018/0112731 A1
(43) Pub. Date: Apr. 26, 2018

(54) Actuator Having Controlled Blocking Of An End Position And Method For Operating A Parking Brake Having Such An Actuator

(71) Applicant: Thomas Magnete GmbH, Herdorf (DE)

(72) Inventors: Marc Leinweber, Neunkirchen (DE); Mathias Friedrich, Siegen (DE); Christian Häberle, Siegen (DE)

(21) Appl. No.: 15/790,835

(22) Filed: Oct. 23, 2017

(30) Foreign Application Priority Data
Oct. 26, 2016 (DE) 10 2016 012 792

(51) Int. Cl. F16D 65/16

(52) U.S. Cl. CPC F16D 65/16; F16D 2121/04

(57) ABSTRACT

An actuator having controlled blocking of an end position and a method for operating a parking brake having such an actuator. The blocking device according to the present disclosure is intended to be constructed to be very wear-resistant and fracture-resistant and the force transmission path of the blocking device is not intended to be directed via the electromagnet which actuates the blocking device. The electromagnet in the state supplied with current presses a blocking cone into a piston counter to a spring by means of a tappet, wherein the blocking cone presses a group of balls which are supported in openings of the piston outwards by means of a conical face and wherein these balls are supported, on the one hand, on a shoulder of a blocking sleeve which is connected to a cylinder and, on the other hand, on the openings of the piston and thereby block a movement of the piston out of the end position thereof. Such a system can be used on vehicles having an electrohydraulically actuated parking brake.

### CROSS-REFERENCE TO RELATED APPLICATIONS

This application claims the benefit of German Application No. 10 2016 012 792 filed on Oct. 26, 2016. The entire disclosure of the above application is incorporated herein by reference.

### FIELD

The present disclosure relates to an actuator having electromagnetic blocking of an end position and a method for operating a parking brake which is controlled by this actuator.

### BACKGROUND

This section provides background information related to the present disclosure which is not necessarily prior art.

Vehicles can be provided with a parking brake and the previously conventional mechanical parking brakes are often being replaced with electrically or electrohydraulically actuated parking brakes.

In this instance, an electrohydraulic actuation has to be locked in particular to prevent application of the parking brake during the travel of the vehicle. In the case to be considered here, the locking is carried out to prevent inadvertent application of the parking brake in that the actuator which actuates the parking brake is mechanically blocked in the end position in which the parking brake is deactivated. The mechanical blocking is actuated by an electromagnet.

Such parking brakes and mechanical blocking devices are known but the known blocking devices have the following disadvantages:
known blocking devices have sheet metal blocking elements which are expensive to produce, can become worn and break;
known blocking devices direct the force transmission path to block the actuator via the actuating electromagnet, which makes the electromagnet more expensive.

There are also known connection elements having blocking devices for hydraulic lines which use balls as blocking members.

### SUMMARY

This section provides a general summary of the disclosure, and is not a comprehensive disclosure of its full scope or all of its features.

The blocking device according to the present disclosure is intended to be constructed to be very wear-resistant and fracture-resistant and the force transmission path of the blocking device is not intended to be directed via the electromagnet which actuates the blocking device.

The actuator for actuating the parking brake is a hydraulic actuator, comprising a cylinder and a piston. The piston is brought into the first end position by a hydraulic pressing force counter to the force of a spring when the cylinder is connected to a pressure source, wherein the parking brake is released in the first end position.

In the second end position, the parking brake is applied, the spring brings the piston into the second end position, in this case there is no hydraulic pressing force because the cylinder is connected to a return to the tank.

A very robust blocking device is known from the rapid-fit couplings for hydraulic hoses, in this case balls are pressed inwards by a manually actuated sliding sleeve having a conical face and bring about at that location a locking of a hose-side journal against a sleeve fixed to a housing.

This solution cannot be transferred to the blocking device sought here in the unchanged state because in this instance an electromagnet having a tappet is provided for actuation. Therefore, it is advantageous to allow the movement of the balls to take place in an outward direction during locking.

To this end, the tappet of the electromagnet actuates a blocking cone and this blocking cone presses the balls outwards. In this case, the balls are guided in the piston by openings.

During this movement, the balls strike a shoulder of a blocking sleeve which is rounded or also conical.

Such a system can be used in vehicles having an electrohydraulically actuated parking brake.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 shows the blocking system for the actuator in the unlocked state;

FIG. 2 shows the blocking system for the actuator in the locked state.

Corresponding reference numerals indicate corresponding parts throughout the several views of the drawings.

### DETAILED DESCRIPTION

Example embodiments will now be described more fully with reference to the accompanying drawings.

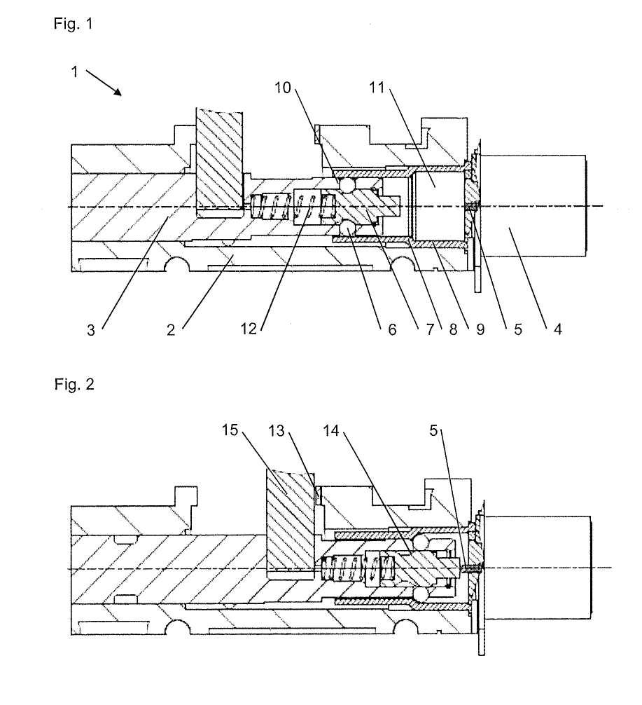

The actuator 1 according to FIG. 1 and FIG. 2 is provided with a cylinder 2 and a piston 3, wherein the piston is constructed to be able to be blocked in a first end position.

In this case, the blocking device is controlled by an electromagnet 4 by the electromagnet 4 pressing a blocking cone 7 into the piston 3 in the state supplied with current counter to a spring 12 by means of a tappet 5 and in this case the blocking cone 7 presses a group of balls 6 which are supported in openings 10 of the piston 3 outwards by means of a conical face 14.

These balls 6 are then supported, on the one hand, on the shoulder 8 of a blocking sleeve 9 and, on the other hand, on the openings 10 of the piston 3.

A movement of the piston 3 out of the end position thereof is thereby blocked.

In the state of the electromagnet 4 not supplied with current, the spring 12 presses the tappet 5 out of the piston 3, wherein the balls 6 are pressed inwards by the shoulder 8 as a result of the displacement of the blocking cone 7. As a result of the support from the balls 6 which is then not present between the shoulder 8 and the openings 10, a movement of the piston 3 out of the first end position thereof is released.

Advantageously, the electromagnet 4 seals the movement space 11 of the piston 3.

The piston 3 takes up the first end position thereof when the bar 15 which is moved by the piston abuts the stop 13. When the piston 3 is blocked in the first end position, the force transmission path for blocking the piston advantageously extends via the openings 10, the balls 6, the blocking sleeve 9 and the cylinder 2, wherein the blocking cone 7 radially supports the balls 6.

In order to operate the parking brake, it is actuated by an actuator 1 by a cylinder 2 of the actuator being acted on with operating fluid from a pressure source in order to move a piston 3 of the actuator into a first end position, and the parking brake being released when the piston 3 takes up the first end position.

In order to move the piston 3 into a second end position, the operating fluid can flow back into a storage tank and a spring determines the position of the piston in the second end position, wherein the parking brake is applied.

The piston 3 is blocked in the first end position when an electromagnet 4 is supplied with current and consequently a tappet 5 of the electromagnet presses a blocking cone 7 into the piston 3 of the actuator 1.

In this case, the blocking cone 7 presses balls 6 which are supported in openings 10 of the piston 3 outwards by means of a conical face 14 and these balls 6 are supported, on the one hand, on the openings 10 and, on the other hand, on a shoulder 8 of a blocking sleeve 9 which is connected to the cylinder 2. The balls thereby prevent a movement of the piston 3 out of the end position thereof.

When the electromagnet is not supplied with current, a spring 12 presses the blocking cone 7 and the tappet 5 out of the piston again, whereby the balls 6 are redirected inwards and the piston 3 is no longer blocked in the first end position.

### LIST OF REFERENCE NUMERALS

1. Actuator
2. Cylinder
3. Piston
4. Electromagnet
5. Tappet
6. Ball
7. Blocking cone
8. Shoulder
9. Blocking sleeve
10. Opening
11. Movement space
12. Spring
13. Stop
14. Conical face
15. Bar

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An actuator comprising:
a cylinder and a piston, wherein the piston is constructed to be able to be blocked in a first end position by an electromagnet in a controlled manner, such that the electromagnet in a state supplied with current presses a blocking cone into the piston counter to a spring by a tappet, wherein the blocking cone presses a group of balls which are supported in openings of the piston outwards by a conical face and wherein the balls are supported, on the one hand, on a shoulder of a blocking sleeve which is connected to the cylinder and, on the other hand, on the openings of the piston and thereby block a movement of the piston out of the first end position thereof, and wherein in the state of the electromagnet not supplied with current the spring presses the blocking cone and the tappet out of the piston, wherein the balls are pressed inwards by the shoulder as a result of the displacement of the blocking cone and, as a result of the support from the balls which is then not present between the shoulder and the openings, a movement of the piston out of the first end position thereof is released.

2. The actuator according to claim 1, wherein the electromagnet seals a movement space of the piston.

3. The actuator according to claim 1, wherein the piston takes up the first end position thereof when a bar which is actuated by the piston abuts a stop.

4. The actuator according to claim 1, wherein, in the event of the piston being blocked in the first end position, a force transmission path for blocking the piston extends via the openings, the balls, the blocking sleeve and the cylinder, wherein the blocking cone radially supports the balls.

5. A method for operating a parking brake, comprising:
the parking brake is actuated by an actuator by,
in order to move a piston into a first end position, a cylinder of the actuator being acted on with operating fluid from a pressure source and the parking brake being released when the piston takes up the first end position, and,
in order to move the piston into a second end position, the operating fluid being able to flow back into a storage tank and a spring determining the position of the piston in the second end position, wherein the parking brake is applied, and
in that the piston is blocked in the first end position when an electromagnet is supplied with current and consequently a tappet of the electromagnet presses a blocking cone into the piston of the actuator, wherein the blocking cone presses balls which are supported in openings of the piston outwards by a conical face and the balls are supported, on the one hand, on the openings and, on the other hand, on a shoulder of a blocking sleeve which is connected to the cylinder and thereby prevent a movement of the piston out of the first end position thereof,
wherein the spring presses the blocking cone and the tappet out of the piston again when the electromagnet is not supplied with current, whereby the balls are redirected inwards and the piston is no longer blocked in the first end position.

6. An actuator for use with a parking brake, comprising:
a cylinder;
a piston movably positioned in the cylinder between a first end position and a second end position;
a blocking sleeve connected to the cylinder having a blocking shoulder; and
a blocking device movable relative to the piston and having a blocking member configured to engage the blocking shoulder;
wherein when the blocking device is in a first position, the blocking member extends radially outward to engage the blocking shoulder to block the piston in the first end position;
wherein when the blocking device is in a second position, the blocking member radially retracts inward to disengage the blocking shoulder to allow the piston to move to the second end position.

7. The actuator of claim 6, wherein in the first end position, the parking brake is disengaged and in the second end position, the parking brake is applied.

8. The actuator of claim 6, wherein the blocking device includes a blocking cone positioned within the piston and movable between the first position and the second position.

9. The actuator of claim 8, wherein the blocking cone is biased by a spring positioned within the piston.

10. The actuator of claim 9, further comprising an electromagnet, wherein upon actuation of the electromagnet, the blocking cone is pressed into the piston counter to the spring whereby the blocking member extends radially outward to engage the blocking shoulder; and
wherein when current is not supplied to the electromagnet, the spring presses the blocking cone out of the piston whereby the blocking member retracts inward from the blocking shoulder causing movement of the piston from the first end position to the second end position.

11. The actuator of claim 10, wherein the blocking member includes a plurality of balls positioned in openings in the piston.

12. The actuator of claim 6, further comprising a bar movable by the piston and a stop, wherein when the piston is in the first end position, the bar abuts the stop.

13. The actuator of claim 10, wherein the electromagnet moves a tappet upon being supplied with current.
